(19) United States
(12) Patent Application Publication
(10) Pub. No.: US 2017/0249617 A1
(43) Pub. Date: Aug. 31, 2017

(54) WEIGHING SYSTEM

(71) Applicant: TOSHIBA TEC KABUSHIKI KAISHA, Tokyo (JP)

(72) Inventor: Atsushi OKAMURA, Mishima Shizuoka (JP)

(21) Appl. No.: 15/439,700

(22) Filed: Feb. 22, 2017

(30) Foreign Application Priority Data
Feb. 29, 2016 (JP) 2016-037686

(51) Int. Cl. G06Q 20/20; G06K 9/46; H04N 7/18; G06Q 30/02; G01G 19/415

(52) U.S. Cl. CPC G06Q 20/208; G06Q 30/0283; G01G 19/415; H04N 7/183; G06K 9/4604

(57) ABSTRACT

A weighing system according to an embodiment includes a scale that measures a total weight of one or more containers, each containing a commodity, placed on the scale. An image capturing sensor captures an image of the one or more containers and commodity information included on one or more of the containers. A processor calculates a weight of an unmeasured commodity included in the container on which no commodity information is included based on: the total weight measured by the scale, the determined weight of the container on which the commodity information is included and the commodity included therein, and the determined weight of the container on which no commodity information is included.

### CROSS-REFERENCE TO RELATED APPLICATION

This application is based upon and claims the benefit of priority from Japanese Patent Application No. 2016-037686, filed Feb. 29, 2016, the entire contents of which are incorporated herein by reference.

### FIELD

Embodiments described herein relate generally to a weighing system.

### BACKGROUND

A large retail store such as a supermarket may sell various commodities by weight. That is, a weight of a commodity a customer wants to purchase is measured to sell the commodity. To purchase the commodity that is sold by weight, the customer puts a specific quantity of the commodity he or she needs in a container. The customer places the container in which the commodity is put on a weighing device. With this operation, the weighing device calculates a price corresponding to the weight of the commodity.

There is a case in which a commodity already weighed is also provided on a sales floor with the sell by weight price already provided. A label with a printed code symbol representing a price corresponding to the weight of the commodity is attached to the commodity that has already been weighed. Thus, in such a case, it is not necessary for the customer to weigh the commodity again. However, the customer may place both a commodity already weighed and a commodity not yet weighed on the weighing device by mistake. In this case, the weighing device measures the weight of the commodities already weighed and the commodities not yet weighed. Thus, in such a case, the weighing device cannot measure the weight of only the commodity not yet weighed alone, without including the weight of the commodity already weighed.

### DESCRIPTION OF THE DRAWINGS

FIG. 1 is a perspective view illustrating a weighing system according to an embodiment;

FIG. 2 is a block diagram illustrating an example hardware arrangement of the weighing system;

FIG. 3 illustrates an example data structure of a container master file;

FIG. 4 is an example functional block diagram of the weighing system;

FIG. 5 illustrates an example of container list information;

FIG. 6 is a flowchart illustrating an example flow of a calculation processing;

FIG. 7 is a flowchart illustrating an example flow of a container identification processing; and

FIG. 8 is a flowchart illustrating an example flow of a commodity information reading processing.

### DETAILED DESCRIPTION

A weighing system according to an embodiment includes a scale that measures a total weight of one or more containers, each containing a commodity, placed on the scale. An image capturing sensor captures an image of the one or more containers and commodity information included on one or more of the containers. A processor determines, from the commodity information, a weight of the container on which the commodity information is included, and the commodity included therein. The processor determines, based on the image of the one or more containers, a category of the container on which no commodity information is included. The processor determines, based on the determined category of the container, a weight of the container on which no commodity information is included. The processor calculates a weight of an unmeasured commodity included in the container on which no commodity information is included based on: the total weight measured by the scale, the determined weight of the container on which the commodity information is included and the commodity included therein, and the determined weight of the container on which no commodity information is included.

Hereinafter, a weighing system according to an embodiment is described in detail with reference to the accompanying drawings. The embodiment described below is one embodiment of the weighing system and is not intended to limit the structure and function thereof. The present embodiment is an example weighing system which is introduced to a store such as a supermarket to sell commodities, such as precooked foods and meat, which are sold by weight.

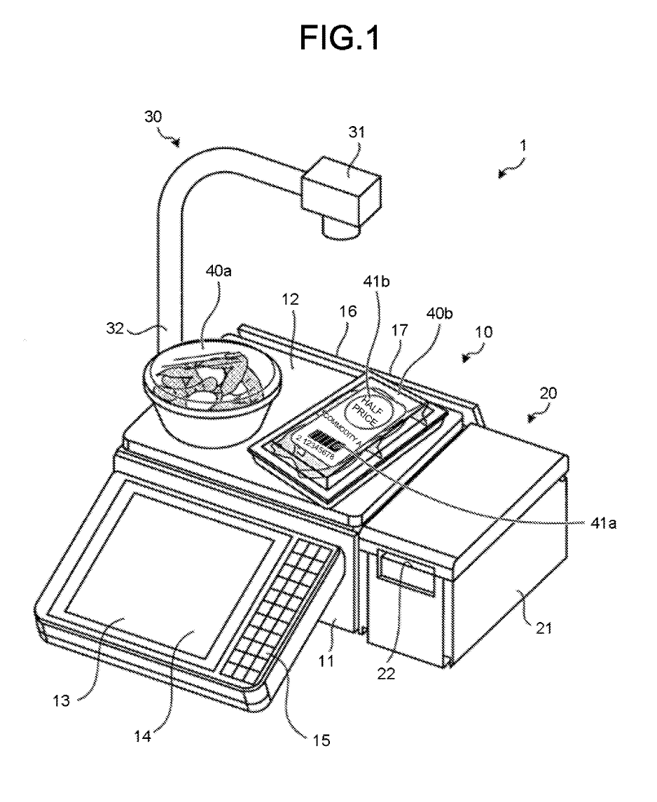

FIG. 1 is a perspective view illustrating a weighing system 1 according to the embodiment. As shown in FIG. 1, the weighing system 1 includes an electronic scale 10, a printer 20 and a camera 30. The electronic scale 10 shown in FIG. 1 is in a state in which containers 40a and 40b are placed thereon. The container 40b is provided with commodity information 41a and 41b relating to a weighed commodity in the container 40b. The commodity information 41a, for example, is a commodity label on which a code symbol such as a barcode or a two-dimensional code is printed. The commodity information 41b, for example, is a seal on which a figure indicating a half price discount is printed. Furthermore, the commodity information 41a and 41b is not limited to the foregoing forms. For example, the commodity information 41a and 41b may include numerals or characters. Hereinafter, the containers 40a and 40b are referred to as a container 40 if not specifically distinguished. Further, the commodity information 41a and 41b is referred to as commodity information 41 if not specifically distinguished.

The electronic scale 10 measures the weight of the commodity. The electronic scale 10 includes a housing 11, a scale pan 12, a first display section 13, a first touch panel 14, a keyboard 15, a second display section 16, and a second touch panel 17.

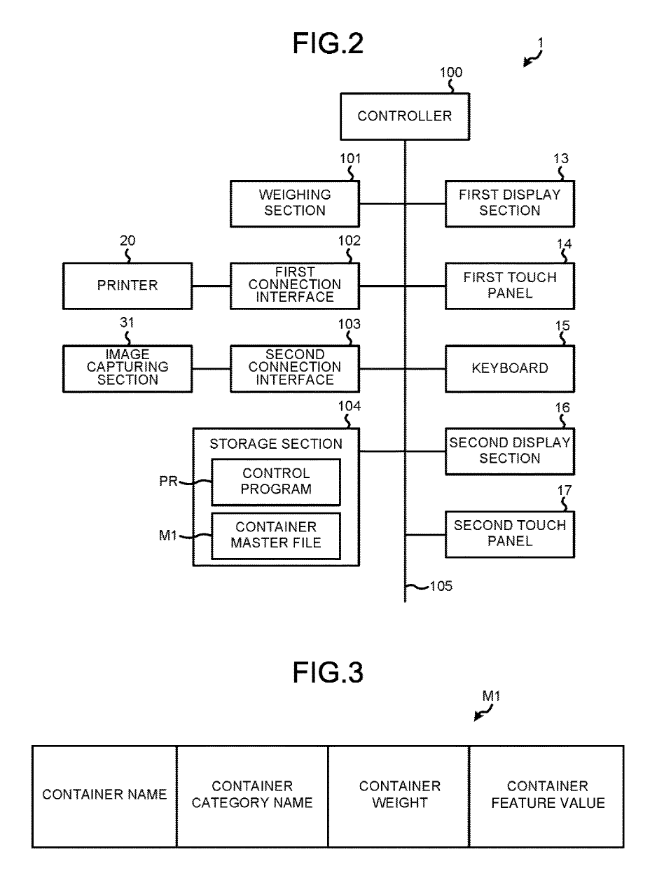

The housing 11 protects a controller 100 and a weighing section 101 (refer to FIG. 2) within the electronic scale 10. The electronic scale 10 includes the scale pan 12, arranged on the surface of the housing 11, for placing the commodity to be weighed thereon. The electronic scale 10 includes the first display section 13 at the front surface thereof. The first display section 13 is, for example, a display device such as a liquid crystal display for viewing by a store clerk. The first display section 13 includes the first touch panel 14 for receiving input for an operation with a finger or a dedicated stylus. The electronic scale 10 includes the keyboard 15 at the right side of the first display section 13 and the first touch panel 14. The keyboard 15 includes keys such as numeric keys for inputting various operations.

The electronic scale 10 includes the second display section 16 at the back side. The second display section 16 is, for example, a display device such a liquid crystal display for viewing by a customer. The second display section 16 includes the second touch panel 17 for receiving input for an operation with a finger or a dedicated stylus.

The printer 20 prints a label and a receipt. The printer 20 is provided with a housing 21 and an issuing port 22. The housing 21 protects a printing section (not shown) built in the printer 20. The printer 20 includes the issuing port 22 at the font surface. The issuing port 22 discharges a printed label and receipt.

The camera 30 includes an image capturing section 31 and a support section 32 for supporting the image capturing section 31. The image capturing section 31 includes an image capturing device such as a CCD (Charge Coupled Device) or a CMOS (Complementary Metal-Oxide Semiconductor). The support section 32 supports the image capturing section 31 over the scale pan 12. In this way, the image capturing section 31 photographs the commodity placed on the scale pan 12. Specifically, the image capturing section 31 photographs the container 40, the commodity in the container 40, and the commodity information 41 relating to the weighed commodity in the container 40.

Next, the hardware structure of the weighing system 1 mentioned above is described. FIG. 2 is a block diagram illustrating an example hardware arrangement of the weighing system 1. The weighing system 1 includes a controller 100 for collectively controlling various operations and each section of the electronic scale 10. The controller 100 is a microcomputer equipped with a CPU (Central Processing Unit), a ROM (Read Only Memory), a RAM (Random Access Memory), and an RTC (Real Time Clock). The CPU executes various computing processing to control various functions of the weighing system 1. The ROM stores various programs and data. The RAM temporarily stores various programs and various data in a rewritable manner. The RTC counts the current date and time.

The controller 100 is connected with the first display section 13, the first touch panel 14, the keyboard 15, the second display section 16, the second touch panel 17, the weighing section 101, a first connection interface 102, a second connection interface 103 and a storage section 104 via a bus line 105. The controller 100 is connected with the printer 20 via the first connection interface 102. Further, the controller 100 is connected with the image capturing section 31 via the second connection interface 103.

The controller 100 controls the first display section 13, the first touch panel 14, the keyboard 15, the second display section 16, the second touch panel 17, the weighing section 101, the first connection interface 102, the second connection interface 103 and the storage section 104. The controller 100 controls the printer 20 via the first connection interface 102. Further, the controller 100 controls the image capturing section 31 via the second connection interface 103.

The weighing section 101 weighs the container 40 placed on the scale pan 12 and the commodity in the container 40. The weighing section 101 is provided with a load cell (not shown) and an analog/digital conversion circuit (not shown). The load cell connected with the scale pan 12 is a sensor for measuring the weight of items placed on the scale pan 12. The load cell outputs a measurement value, i.e., analog value, corresponding to the weight of a measured object containing the commodity. The analog/digital conversion circuit converts the analog value to a digital value.

The printer 20 is equipped with the printing section (not shown) for printing. The controller 100 uses a part of an area of the RAM as a printing buffer to control the printing section. In this way, the controller 100 drives a thermal head and a pulse motor of the printer 20 to print the label and the receipt.

The storage section 104 is a storage device such as an HDD (Hard Disk Drive) and/or an SSD (Solid State Drive). The storage section 104 stores various programs executed by the controller 100 (CPU) and a database. The storage section 104 stores, for example, a control program PR and a container master file M1. The control program PR enables the controller 100 to realize various functions of the weighing system 1.

FIG. 3 illustrates an example data structure of the container master file M1. The container master file M1 is a database including information relating to the container 40 in which the commodity is held. The storage section 104 may store one or a plurality of databases into which the container master file M1 is divided. The container master file M1 may be stored in other devices such as a store server (not shown) instead of the storage section 104. In such a case, the weighing system 1 extracts necessary information from the device which stores the container master file M1 via a communication interface (not shown).

The container master file M1 stores a container code, a container category name, a weight of a container, and a feature value of a container for each category of the container 40. The container code is identification information for identifying the category of the container 40. The container category name is a name of each category of the container 40. The weight of the container is weight of the container 40, according to the category. The feature value of the container 40 is obtained by, for example, parameterizing a shape of the container 40, a size of the container 40, and/or an appearance of the container 40 such as a texture or color.

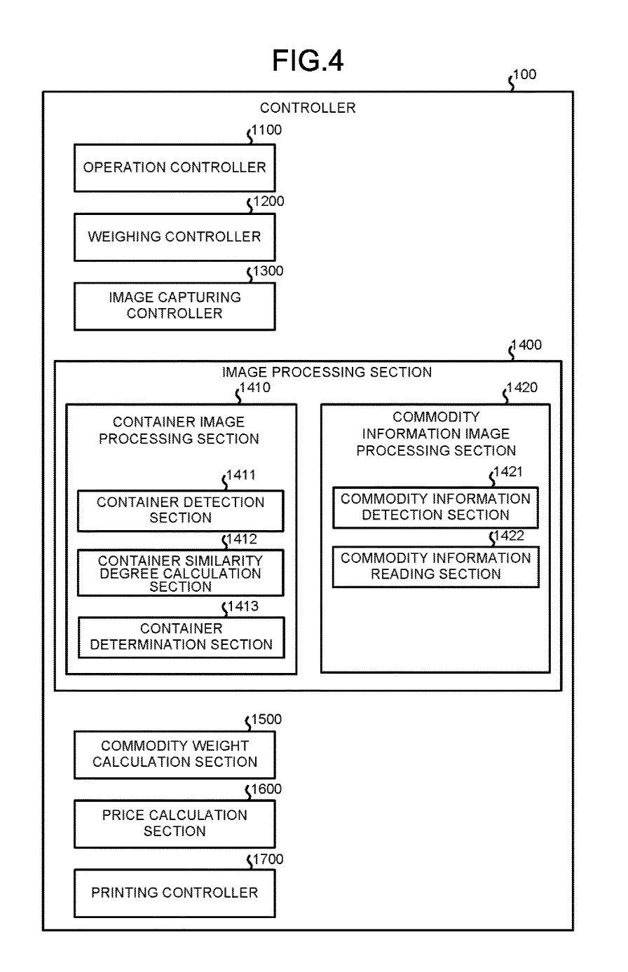

Next, the functional features of the weighing system 1 are described. FIG. 4 is an example functional block diagram of the weighing system 1.

The CPU of the controller 100 operates according to the control program PR copied or decompressed on the RAM to realize each functional section shown in FIG. 4 on the RAM. In particular, the weighing system 1 includes, as functional sections, an operation controller 1100, a weighing controller 1200, an image capturing controller 1300, an image processing section 1400, a commodity weight calculation section 1500, a price calculation section 1600, and a printing controller 1700. The image processing section 1400 is provided with a container image processing section 1410 and a commodity information image processing section 1420. The container image processing section 1410 is provided with a container detection section 1411, a container similarity degree calculation section 1412 and a container determination section 1413. The commodity information image processing section 1420 is provided with a commodity information detection section 1421, and a commodity information reading section 1422.

In one embodiment, the controller 100 is a processor that is programmed to carry out the functions of the operation controller 1100, the weighing controller 1200, the image capturing controller 1300, the image processing section 1400, the container image processing section 1410, the container detection section 1411, the container similarity degree calculation section 1412, the container determination section 1413, the commodity information image processing section 1420, the commodity information detection section 1421, the commodity information reading section 1422, the commodity weight calculation section 1500, the price calculation section 1600, and the printing controller 1700.

In another embodiment, the controller unit 11 is a hardware controller, e.g., an application specific integrated circuit (ASIC) and field programmable gate array (FPGA), that is configured to carry out the functions of the operation controller 1100, the weighing controller 1200, the image capturing controller 1300, the image processing section 1400, the container image processing section 1410, the container detection section 1411, the container similarity degree calculation section 1412, the container determination section 1413, the commodity information image processing section 1420, the commodity information detection section 1421, the commodity information reading section 1422, the commodity weight calculation section 1500, the price calculation section 1600, and the printing controller 1700.

The operation controller 1100 controls the first touch panel 14, the keyboard 15 and the second touch panel 17 to receive various operations.

The weighing controller 1200 controls the weighing section 101 to measure the weight of an article placed on the scale pan 12. For example, the weighing controller 1200 measures the weight of the container 40 placed on the scale pan 12 and the commodity in the container 40.

The image capturing controller 1300 controls the image capturing section 31 to photograph the article placed on the scale pan 12. For example, the image capturing controller 1300 enables the image capturing section 31 to photograph the container 40 measured by the weighing section 101 and the commodity information 41 relating to the measured commodity in the container 40. The image capturing controller 1300 enables the image capturing section 31 to start an image capturing operation when the weight of the article placed on the scale pan 12 is measured. The image capturing controller 1300 stores the image captured by the image capturing section 31 in the RAM.

The image capturing controller 1300 enables the image capturing section 31 to capture a container identification image that is used to identify the container 40 by the container image processing section 1410. The image capturing controller 1300 also enables the image capturing section 31 to capture a commodity information reading image used to read the commodity information 41 by the commodity information image processing section 1420, using different image capturing settings. In order to identify the container 40, the container image processing section 1410 captures the container identification image using specific settings, such as an aperture setting for adjusting the brightness of an image, a contrast setting for adjusting the intensity of the image and a sharpness setting capable of clearly distinguishing contours. On the other hand, the commodity information image processing section 1420 captures the commodity information reading image using settings so as to accurately read the commodity information 41 on a white base background. Thus, the image capturing controller 1300 acting as an image capturing control module enables the image capturing section 31 to capture the container identification image and the commodity information reading image with different settings. The image capturing controller 1300 changes from a first setting to a second setting under which the commodity information reading image is captured immediately after the container identification image is captured in the first setting. The order of the capturing of the container identification image and the commodity information reading image is an example. That is, the capturing of the container identification image and the commodity information reading image may be executed in a different.

The image capturing controller 1300 enables the image capturing section 31 to capture the commodity information reading image without capturing the container identification image when the container 40 is not placed on the scale pan 12. In other words, the image capturing controller 1300 enables the image capturing section 31 to capture the commodity information reading image without capturing the container identification image when the weighing controller 1200 does not detect the weight.

The image processing section 1400 processes the images captured by the image capturing controller 1300 to read various information from the images captured by the image capturing controller 1300. The image processing section 1400 generates container list information T1 in which information relating to the container 40 and information relating to the commodity information 41 are associated with one another for each container 40 contained in the images captured by the image capturing controller 1300.

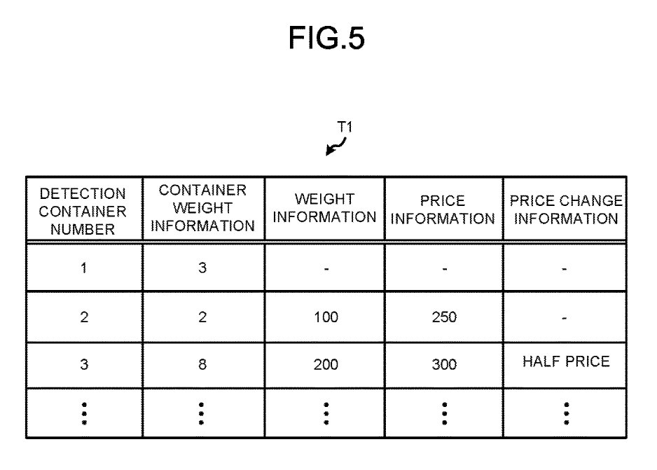

FIG. 5 is a view illustrating an example of the container list information T1. For example, the container list information T1 stores a detected container number, container weight information, weight information, price information and price change information in an associated manner. The detected container number identifies the container 40 contained in the image captured by the image capturing controller 1300. The container weight information is the weight of the container 40 contained in the image captured by the image capturing controller 1300. The container weight information is extracted through an image processing by the container image processing section 1410 described later. The weight information indicates the weight of the commodity in the container 40. The price information indicates a price of the commodity in the container 40. The price change information indicates that the price of the measured commodity in the container 40 is changed. For example, the price change information includes information for designating a price such as 10 Yen decrease in price and information for designating a discount rate of the price of the measured commodity such as a half price to change the price. The weight information, the price information and the price change information are determined from the commodity information 41 through the image processing by the commodity information image processing section 1420 described later.

The container image processing section 1410 executes the image processing for identifying the container 40 contained in the container identification image on the basis of the container identification image captured by the image capturing section 31. In other words, the container image processing section 1410 identifies the weight of the container 40 by identifying which one of the categories of the container 40 in the container master file M1 the category of the container 40 contained in the container identification image captured by the image capturing section 31 corresponds to. The container image processing section 1410 includes the container detection section 1411, the container similarity degree calculation section 1412 and the container determination section 1413.

The container detection section 1411 detects one or a plurality of the containers 40 with a pattern matching technology from the container identification images stored in the RAM by the image capturing controller 1300. In particular, the container detection section 1411 extracts counter lines from an image obtained by binarizing the acquired container identification image. In other words, the container detection section 1411 detects the container 40 on the basis of a difference between an image which does not contain the container 40 and the counter lines extracted from an image which contains the container 40. The container detection section 1411 assigns a detection container number for identifying the container 40 in the container list information T1 to each detected container 40.

The container similarity degree calculation section 1412 calculates a container similarity degree between the container 40 detected by the container detection section 1411 and the category of the container 40 registered in the container master file M1. In particular, the container similarity degree calculation section 1412 extracts a container feature value of the appearance of the container 40 detected by the container detection section 1411 from the container identification image of the container 40 captured by the image capturing section 31. At this time, the container similarity degree calculation section 1412 extracts information obtained by parameterizing the shape of the container 40, the size of the container 40 and the appearance of the container 40 such as texture or color as the container feature value of the appearance of the container 40. Alternatively, the container similarity degree calculation section 1412 extracts information obtained by parameterizing all or a part of colors of the container 40 as the container feature value of the appearance of the container 40. Furthermore, the container similarity degree calculation section 1412 may extract the container feature value containing both the container feature value relating to the appearance of the container 40 and the container feature value relating to all or a part of colors of the container 40.

The container similarity degree calculation section 1412 compares the container feature value of the category of the container 40 registered in the container master file M1 with the container feature value of the container 40 contained in the container identification image to calculate the similarity degree. The container similarity degree indicates how similar the container feature value of all or a part of the container 40 is with the category of the container 40 registered in the container master file M1 in a case in which the container feature value of the container 40 registered in the container master file M1 is set to 100%=“the container similarity degree: 1.0”.

The recognition of the article contained in the image in this manner is referred to as general object recognition. Various recognition technologies in the following document are explained in terms of the general object recognition:

Keiji Yanai, “Current State and Future of Generic Object Recognition”, Information Processing Society Journal, Vol. 48, No. SIG16, Internet <URL: http://mm.cs.uec.ac.jp/IPSJ-TCVIM-Yanai.pdf>.

Furthermore, a technology for executing the general object recognition through segmenting an image for each object is explained in the following document:

Jamie Shotton et al., “Semantic Texton Forests for Image Categorization and Segmentation”, Internet <URL: http://cite seerx.ist.psu.edu/viewdoc/download?doi=10.1.1.145.3036&rep=rep1& type=pdf>.

The container determination section 1413 determines which one of the categories of the containers 40 registered in the container master file M1 the container 40 detected by the container detection section 1411 corresponds to. For example, the container determination section 1413 determines the category of the container 40 of which the weight is measured by the weighing section 101 on the basis of the container similarity degree calculated by the container similarity degree calculation section 1412. In particular, the container determination section 1413 determines that the category of the container 40 for which the container similarity degree calculated by the container similarity degree calculation section 1412 is highest is the category of the container 40 detected by the container detection section 1411. In other words, the container determination section 1413 identifies which one of the categories of the container 40 in the container master file M1 the category of the container 40 contained in the container identification image captured by the image capturing section 31 corresponds to. The container determination section 1413 extracts the container weight of the container 40 corresponding to the category identified from the container master file M1. The container determination section 1413 registers the extracted container weight as the container weight information in the container list information T1. The container image processing section 1410 registers the container weight information for each container 40 detected by the container detection section 1411.

The commodity information image processing section 1420 executes the image processing for reading the commodity information 41 contained in the commodity information reading image on the basis of the commodity information reading image captured by the image capturing section 31. In other words, the commodity information image processing section 1420 reads the weight information, the price information and the price change information from the commodity information 41 contained in the commodity information reading image captured by the image capturing section 31.

The commodity information detection section 1421 detects the commodity information 41 for each container 40. There is a case in which the image capturing section 31 photographs a plurality of the containers 40. It is necessary for the commodity information detection section 1421 to identify which one of the containers 40 the detected commodity information 41 relates to if a plurality of the containers 40 is photographed. For example, in a case in which commodity information 41 indicating the half price is attached to the container 40, the commodity information detection section 1421 must set the price of the commodity in the container 40 to which the commodity information 41 is attached to a half price. In other words, the commodity information detection section 1421 cannot set the price of the commodity in the container 40 to the half price if the commodity information 41 indicating the half price is not attached to the container 40. Thus, the commodity information detection section 1421 identifies which one of the containers 40 the detected commodity information 41 relates to. In particular, the commodity information detection section 1421 overlays the counter lines of one or a plurality of the containers 40 extracted by the container detection section 1411 from the container identification image on the commodity information reading image. The commodity information detection section 1421 determines which one of the counter lines of the containers 40 the detected commodity information 41 is located in. The commodity information detection section 1421 determines that the container 40 including the detected commodity information 41 at the inner side of counter lines thereof is the container 40 with the detected commodity information 41. Furthermore, the commodity information detection section 1421 extracts the detection container number assigned to the container 40 detected. The commodity information detection section 1421 uses the result of the container detection section 1411 to detect the commodity information 41. However, the detection method is an example, and the commodity information 41 may be detected with other methods. For example, the commodity information detection section 1421 may individually extract counter lines of the container 40 similar to that by the container detection section 1411.

The commodity information reading section 1422 reads the commodity information 41 detected by the commodity information detection section 1421. The commodity information reading section 1422 can read the commodity information 41 with various methods. For example, the commodity information reading section 1422 may read the commodity information 41 by decoding a code symbol when the commodity information 41 is represented with the code symbol. The commodity information reading section 1422 may read the commodity information 41 with OCR (Optical Character Recognition) when the commodity information 41 is indicated with numerals or characters. The commodity information reading section 1422 may read the commodity information 41 through pattern matching when the commodity information 41 is indicated with figures.

The commodity information reading section 1422 stores various information contained in the read commodity information 41 in the container list information T1 in association with the detected container number extracted by the commodity information detection section 1421. In other words, the commodity information reading section 1422 registers various information contained in the read commodity information 41 in the container list information T1 in association with the detected container number relating to the container 40 of which the commodity information 41 is detected by the commodity information detection section 1421. In particular, the commodity information reading section 1422 registers the read weight information in the container list information T1 on condition that the commodity information 41 contains the weight information. Further, the commodity information reading section 1422 registers the read price information in the container list information T1 on condition that the commodity information 41 contains the price information. Still further, the commodity information reading section 1422 registers the read price change information in the container list information T1 on condition that the commodity information 41 contains the price change information. In other words, the commodity information image processing section 1420 executes a processing for registration of the weight information, the price information and the price change information for individual commodity information 41 detected by the commodity information detection section 1421.

The commodity weight calculation section 1500 calculates an unmeasured commodity weight indicating the weight of the unmeasured commodity placed on the scale pan 12. In other words, the commodity weight calculation section 1500, acting as a first calculation module, calculates the weight of the commodity not yet measured according to the weight measured by the weighing controller 1200, the weight of the category of the container 40 identified by the container image processing section 1410 and the weight read by the commodity information image processing section 1420 from the commodity information 41. In particular, the commodity weight calculation section 1500 calculates a container weight total value indicating a total value of the container weight information in the container list information T1. The commodity weight calculation section 1500 subtracts the container weight total value from the weight measured by the weighing controller 1200 to calculate a container exclusion weight indicating the weight excluding the weight of the container 40. Further, the commodity weight calculation section 1500 calculates a commodity weight total value indicating a total value of the weight information in the container list information T1. The commodity weight calculation section 1500 subtracts the commodity weight total value from the container exclusion weight excluding the weight of the container 40 to calculate the unmeasured commodity weight indicating the weight of the commodity not yet measured.

The price calculation section 1600 calculates a commodity price total amount indicating the total price of the commodity placed on the scale pan 12. In other words, the price calculation section 1600, acting as a third calculation module, calculates the price of the unmeasured commodity on the basis of the unmeasured commodity weight calculated by the commodity weight calculation section 1500 and a price per unit weight of the commodity. In particular, the price calculation section 1600 calculates a read commodity price indicating a total price of the measured commodity. In other words, the price calculation section 1600 calculates the read commodity price indicating the total price after applying the price change information to the price information in the container list information T1. The price calculation section 1600 calculates an unmeasured commodity price indicating a total price of the unmeasured commodity. In other words, the price calculation section 1600 multiplies a unit price per unit weight of the commodity in the container 40 by the weight calculated by the commodity weight calculation section 1500 to calculate the unmeasured commodity price. The price calculation section 1600 adds the unmeasured commodity price to the read commodity price to calculate the commodity price total amount. The unit price per unit weight of the commodity in the container 40 is specified through various methods. For example, the unit price per unit weight is determined according to an operation received by the first touch panel 14. Alternatively, the unit price per unit weight may be a unit price per weight of the commodity in the container 40 with respect to each category of the container 40.

The printing controller 1700 prints a receipt on which the price of the commodity calculated by the price calculation 1600 is printed.

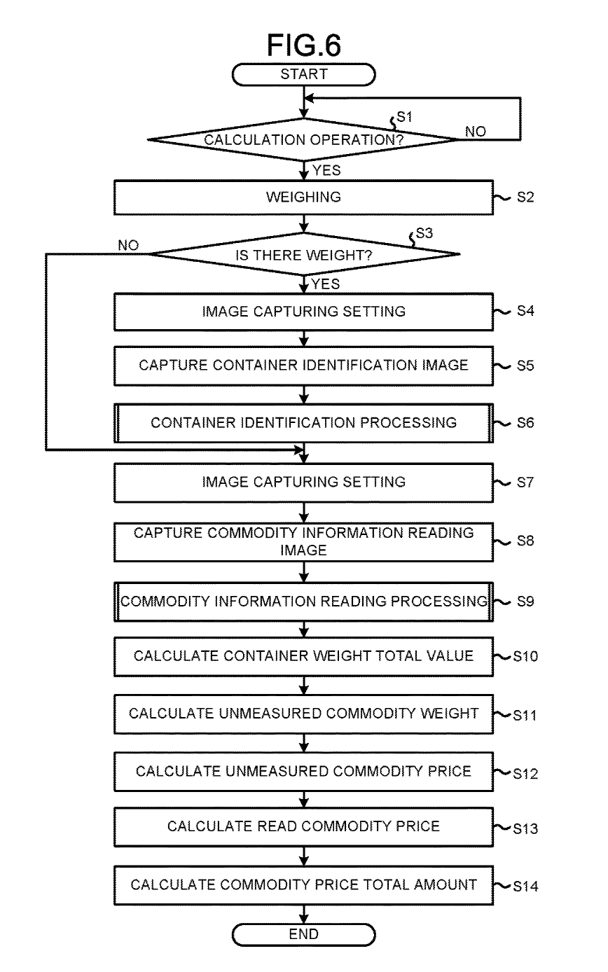

Next, a calculation processing executed according to the control program PR by the controller 100 of the weighing system 1 of the foregoing embodiment is described. The calculation processing is a processing for calculating the total price of the commodity placed on the scale pan 12. FIG. 6 is a flowchart illustrating an example flow of the calculation processing executed by the weighing system 1 according to the embodiment.

First, the operation controller 1100 of the weighing system 1 determines whether or not an operation for calculating the total price of the commodity placed on the scale pan 12 is received (Act S1). If the operation for calculating the total price is not received (No in Act S1), the weighing system 1 stands by until the operation is received.

On the other hand, if the operation for calculating the total price is received (Yes in Act S1), the weighing controller 1200 of the weighing system 1 measures the weight of the articles placed on the scale pan 12 (Act S2). The weighing controller 1200 of the weighing system 1 determines whether any weight is on the scale pan 12 (Act S3). In other words, the weighing controller 1200 determines whether or not the articles are placed on the scale pan 12. If the weighing controller 1200 determines that there is no weight on the scale pan 12 (No in Act S3), the weighing system 1 proceeds to the processing in Act S7.

On the other hand, if there is weight (Yes in Act S3), the image capturing controller 1300 of the weighing system 1 sets the capturing setting of the image capturing section 31 to the setting for capturing the container identification image (Act S4). The image capturing controller 1300 of the weighing system 1 enables the image capturing section 31 to capture the container identification image (Act S5).

The weighing system 1 executes a container identification processing described later (Act S6).

The image capturing controller 1300 of the weighing system 1 sets the capturing setting of the image capturing section 31 to the setting for capturing the commodity information reading image (Act S7). The image capturing controller 1300 of the weighing system 1 enables the image capturing section 31 to capture the commodity information reading image (Act S8).

The weighing system 1 executes a commodity information reading processing described later (Act S9).

The commodity weight calculation section 1500 of the weighing system 1 calculates the container weight total value indicating the total weight of the container 40 placed on the scale pan 12 (Act S10). The commodity weight calculation section 1500 of the weighing system 1 calculates the unmeasured commodity weight indicating the weight of the unmeasured commodity placed on the scale pan 12 as described above (Act S11).

The price calculation section 1600 of the weighing system 1 calculates the unmeasured commodity price indicating the total price of the unmeasured commodity as described above (Act S12). The price calculation section 1600 of the weighing system 1 calculates the read commodity price indicating the total price of the measured commodity (Act S13). The price calculation section 1600 of the weighing system 1 calculates the commodity price total amount indicating the total price of the commodity placed on the scale pan 12 (Act S14).

In this way, the weighing system 1 terminates the calculation processing.

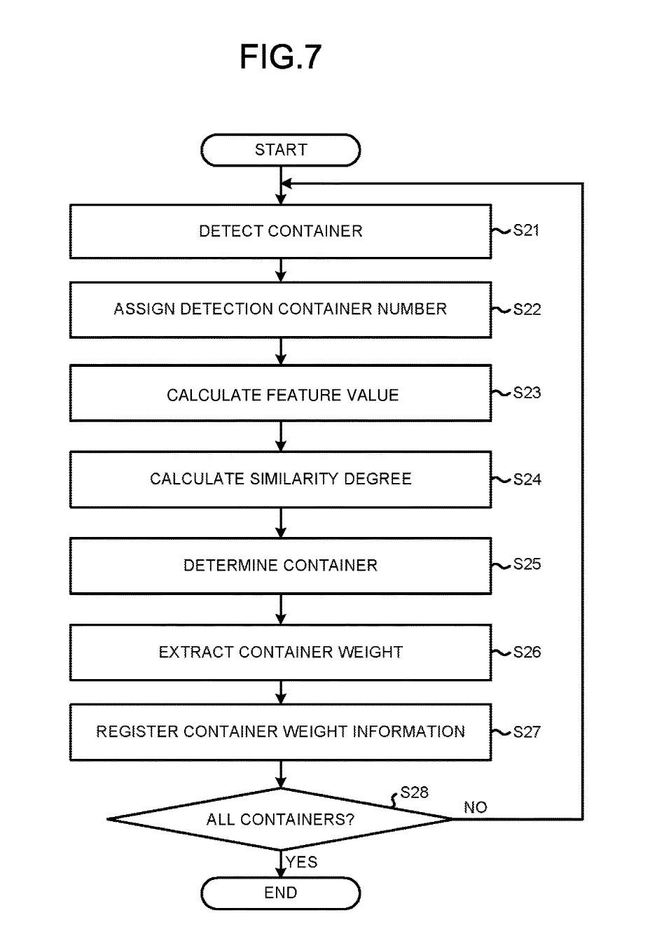

The container identification processing executed according to the control program PR by the controller 100 of the weighing system 1 of the foregoing embodiment is described. FIG. 7 is a flowchart illustrating an example flow of the container identification processing executed by the weighing system 1 according to the embodiment.

The container detection section 1411 of the weighing system 1 detects the container 40 from the container identification image captured by the image capturing controller 1300 (Act S21). The container detection section 1411 of the weighing system 1 assigns the detected container number in the container list information T1 to the detected container 40 (Act S22).

The container similarity degree calculation section 1412 of the weighing system 1 calculates the container feature value of the container 40 detected by the container detection section 1411 (Act S23). The container similarity degree calculation section 1412 of the weighing system 1 calculates the container similarity degree between the calculated container feature value and the container feature value of each category of the container 40 contained in the container master file M1 (Act S24). The container determination section 1413 of the weighing system 1 determines that the container 40 with the highest container similarity degree is the container 40 contained in the image (Act S25).

The container determination section 1413 of the weighing system 1 extracts the container weight in the category of the determined container from the container master file M1 (Act S26). The container determination section 1413 of the weighing system 1 registers the extracted container weight in the container list information T1 as the container weight information (Act S27).

The container detection section 1411 of the weighing system 1 determines whether or not the container identification processing is executed for all the containers 40 contained in the container identification image (Act S28). If the container identification processing is not executed for all the containers 40 contained in the container identification image (No in Act S28), the container detection section 1411 of the weighing system 1 proceeds to the processing in Act S21. On the other hand, when the container identification processing is executed for all the containers 40 contained in the container identification image (Yes in Act S28), the weighing system 1 terminates the container identification processing.

In this way, the weighing system 1 terminates the container identification processing.

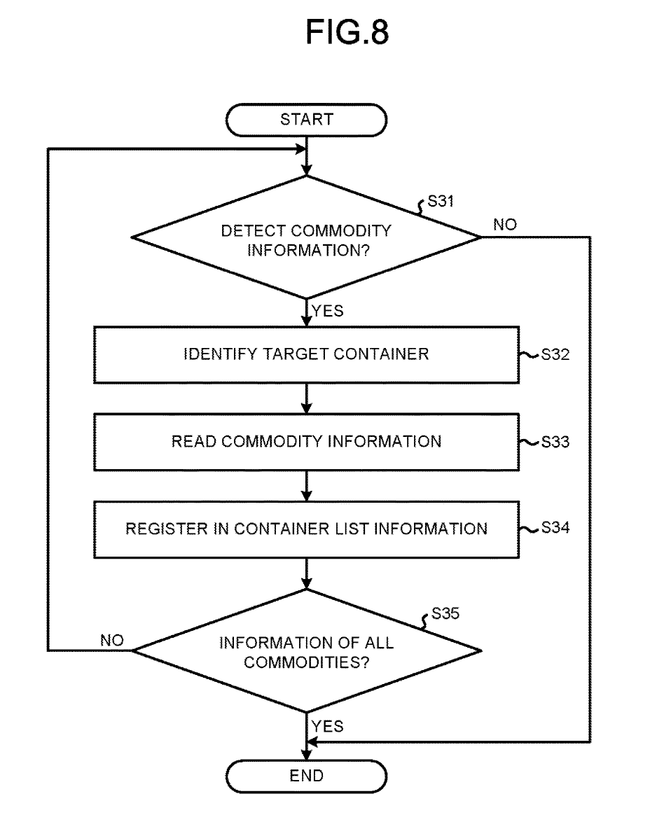

The commodity information reading processing executed according to the control program PR by the controller 100 of the weighing system 1 of the foregoing embodiment is described. FIG. 8 is a flowchart illustrating an example flow of the commodity information reading processing executed by the weighing system 1 according to the embodiment.

The commodity information detection section 1421 of the weighing system 1 determines whether or not the commodity information 41 is detected from the commodity information reading image (Act S31). If the commodity information 41 is not detected (No in Act S31), the weighing system 1 terminates the commodity information reading processing.

On the other hand, if the commodity information 41 is detected (Yes in Act S31), the commodity information detection section 1421 of the weighing system 1 identifies which one of the containers 40 the detected commodity information 41 belongs to (Act S32). The commodity information reading section 1422 of the weighing system 1 reads the detected commodity information 41 (Act S33). The commodity information reading section 1422 of the weighing system 1 registers various information contained in the commodity information 41 in the container list information T1 (Act S34).

The commodity information detection section 1421 of the weighing system 1 determines whether or not all the commodity information 41 in the commodity information reading image is read (Act S35). If all the commodity information 41 is not read (No in Act S35), the weighing system 1 proceeds to the processing in Act S31. On the other hand, if all the commodity information 41 is read (Yes in Act S35), the weighing system 1 terminates the commodity information reading processing.

In this way, the weighing system 1 terminates the commodity information reading processing.

As described above, according to the weighing system 1 of the present embodiment, the weighing section 101 measures the weight of the container 40 placed on the scale pan 12 and the weight of the commodity in the container 40. The image capturing section 31 photographs the container 40 measured by the weighing section 101 and the commodity information 41 relating to the measured commodity in the container 40. The container image processing section 1410 identifies the category of the container 40 by carrying out the image processing on the container identification image captured by the image capturing section 31. Further, the container image processing section 1410 extracts the weight of the identified container 40 from the container master file M1. The commodity weight calculation section 1500 calculates the container weight total value indicating the total weight of the container 40. The commodity information image processing section 1420 reads the commodity information 41 by carrying out the image processing on the commodity information reading image captured by the image capturing section 31. The commodity weight calculation section 1500 subtracts the container weight total value included in the commodity information 41 from the weight measured by the weighing section 101 to calculate the unmeasured commodity weight when the weight information is contained in the commodity information 41 read by the commodity information image processing section 1420. Thus, the weighing system 1 of the present embodiment can calculate the weight of the unmeasured commodity.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

The programs executed by each device of the foregoing embodiment and the modification may be incorporated into a storage medium (ROM or storage section) of each device in advance to be provided; however, the present invention is not limited to this. The programs may be recorded in a computer-readable recording medium such as a CD-ROM, a FD (Flexible Disk), a CD-R, a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted through a LAN or an Internet.

Further, the programs executed by each device of the foregoing embodiment and the modification is stored in a computer connected with a network and downloaded via the network to be supplied or may be supplied or distributed via the network such as the Internet.

What is claimed is:

1. A weighing system, comprising:
a scale configured to measure a total weight of one or more containers, each containing a commodity, placed on the scale;
an image capturing sensor configured to capture an image of the one or more containers and commodity information included on one or more of the containers; and
a processor configured to:
determine, from the commodity information, a weight of the container on which the commodity information is included, and the commodity included therein,
determine, based on the image of the one or more containers, a category of the container on which no commodity information is included,
determine, based on the determined category of the container, a weight of the container on which no commodity information is included, and
calculate a weight of an unmeasured commodity included in the container on which no commodity information is included based on:
the total weight measured by the scale,
the determined weight of the container on which the commodity information is included and the commodity included therein, and
the determined weight of the container on which no commodity information is included.

2. The weighing system according to claim 1, wherein the processor is further configured to:
calculate a price of the unmeasured commodity based on the calculated weight of the unmeasured commodity and a price per unit weight of the unmeasured commodity.

3. The weighing system according to claim 2, wherein the processor is further configured to:
determine a price of commodities included in the one or more containers on which the commodity information is included.

4. The weighing system according to claim 3, wherein the processor is further configured to:
calculate a total price of all commodities placed on the scale based on the calculated price of the unmeasured commodity and the determined price of commodities included in the one or more containers on which commodity information is included.

5. The weighing system according to claim 3, wherein the determined price of commodities included in the one or more containers on which commodity information is included is based on the commodity information.

6. The weighing system according to claim 5, wherein the determined price of commodities included in the one or more containers on which commodity information is included is further based on price change information for changing the price of the commodity included in the corresponding commodity information.

7. The weighing system according to claim 1, wherein:
the processor controls the image capturing sensor to capture:
a first image used to determine the category of the container on which no commodity information is included, and
a second image used to read the commodity information.

8. The weighing system according to claim 7, wherein the first image is captured using first settings and the second image is captured using second settings different from the first settings.

9. The weighing system according to claim 7, wherein the processor controls the image capturing sensor to capture the second image without capturing the first image based on a determination that no containers are placed on the scale.

10. A method of weighing commodities, comprising the steps of:
measuring a total weight of one or more containers, each containing a commodity, placed on a scale;
capturing at least one image of the one or more containers and commodity information included on one or more of the containers;
determining, from the commodity information, a weight of the container on which the commodity information is included, and the commodity included therein;
determining, based on the at least one image, a category of the container on which no commodity information is included;
determining, based on the determined category of the container, a weight of the container on which no commodity information is included; and
calculating a weight of an unmeasured commodity included in the container on which no commodity information is included based on:
the total weight measured by the scale,
the determined weight of the container on which the commodity information is included and the commodity included therein, and
the determined weight of the container on which no commodity information is included.

11. The method according to claim 10, further comprising the step of:
calculating a price of the unmeasured commodity based on the calculated weight of the unmeasured commodity and a price per unit weight of the unmeasured commodity.

12. The method according to claim 11, further comprising the step of:
determining a price of commodities included in the one or more containers on which the commodity information is included.

13. The method according to claim 12, further comprising the step of:
calculating a total price of all commodities placed on the scale based on the calculated price of the unmeasured commodity and the determined price of commodities included in the one or more containers on which commodity information is included.

14. The method according to claim 12, wherein the determined price of commodities included in the one or more containers on which commodity information is included is based on the commodity information.

15. The method according to claim 14, wherein the determined price of commodities included in the one or more containers on which commodity information is included is further based on price change information for changing the price of the commodity, the price change information being included in the corresponding commodity information.

16. The method according to claim 10, wherein the at least one image includes:
a first image used to determine the category of the container on which no commodity information is included, and
a second image used to read the commodity information.

17. The method according to claim 16, wherein the first image is captured with an image capturing device using first settings and the second image is captured with the image capturing device using second settings different from the first settings.

18. A non-transitory computer readable medium containing instructions causing a processor to perform a method of weighing commodities, the method comprising the steps of:
measuring a total weight of one or more containers, each containing a commodity, placed on a scale;
capturing at least one image of the one or more containers and commodity information included on one or more of the containers;
determining, from the commodity information, a weight of the container on which the commodity information is included, and the commodity included therein;
determining, based on the at least one image, a category of the container on which no commodity information is included;
determining, based on the determined category of the container, a weight of the container on which no commodity information is included; and
calculating a weight of an unmeasured commodity included in the container on which no commodity information is included based on:
the total weight measured by the scale,
the determined weight of the container on which the commodity information is included and the commodity included therein, and
the determined weight of the container on which no commodity information is included.

19. The non-transitory computer readable medium according to claim 18, wherein the at least one image includes:
a first image captured with an image capturing device using first settings, the first image being used to determine the category of the container on which no commodity information is included, and
a second image captured with the image capturing device using second settings different from the first settings, the second image being used to read the commodity information.

20. The non-transitory computer readable medium according to claim 19, wherein the instructions cause the image capturing device to capture the second image without capturing the first image based on a determination that no containers are placed on the scale.
